(19) United States
(12) Patent Application Publication
(10) Pub. No.: US 2026/0080394 A1
(43) Pub. Date: Mar. 19, 2026

(54) Computer-Implemented Method and System for Transaction by Vendors and Customers

(71) Applicant: Figgers Health Inc., Fort Lauderdale, FL (US)

(72) Inventor: Freddie Figgers, Fort Lauderdale, FL (US)

(21) Appl. No.: 18/890,695

(22) Filed: Sep. 19, 2024

(51) Int. Cl. G06Q 20/38; G06Q 30/018; G06Q 30/0282; G06Q 30/0601

(52) U.S. Cl. CPC G06Q 20/382; G06Q 30/018; G06Q 30/0282; G06Q 30/0633

(57) ABSTRACT

A computer-implemented method for registering vendors and customers within an e-commerce system and facilitating e-commerce transactions is provided. The method includes receiving a registration application from a vendor and receiving a registration application from a customer. The method includes receiving consent from the vendor to conduct background checks. The method includes conducting background checks on the vendor and generating a background check report associated with the vendor. The method includes assigning a risk score to the vendor based on the background check report. The method includes approving or disapproving the vendor's registration based on the review of the background check report and the risk score.

### FIELD OF THE INVENTION

The present invention relates generally to the field of electronic commerce, and more specifically to a computer-implemented method and system for transactions by vendors and customers.

### BACKGROUND

E-commerce platforms have revolutionized the way transactions are conducted, allowing customers and vendors to engage in business activities.

Traditional e-commerce methods and systems often lack unique requirements associated with the provision of services and products. Current methods and systems that facilitate transactions lack robust mechanisms for verifying and authenticating vendors, leading to significant drawbacks and inefficiencies.

One of the drawbacks of existing e-commerce methods and systems is the absence of comprehensive vendor verification and authentication processes. Customers often have limited information about the vendors providing services and products, leading to potential risks such as fraud, substandard service quality, and non-compliance with industry standards. Without proper verification, customers cannot trust that vendors possess the necessary qualifications, certifications, and expertise to perform the required services.

Current methods and systems do not offer customers the ability to thoroughly review the credentials and certifications of vendors. This lack of transparency hinders informed decision-making, as customers are unable to assess the suitability of a vendor for a particular project based on their qualifications and past performance. Consequently, customers may end up engaging with vendors who are ill-equipped to deliver satisfactory results.

Another drawback of existing e-commerce platforms is the limited capability for customers to monitor the progress of works performed by vendors. This lack of visibility can result in miscommunication, delays, and unmet expectations, as customers are often left in the dark about the status of their projects. Effective project tracking is essential for ensuring that services and products are delivered as per agreed timelines and specifications.

While e-commerce systems facilitate payments for services and goods, they often lack robust payment processing mechanisms tailored for transactions. This can lead to complications such as disputes over payment amounts, delays in processing payments, and lack of secure payment channels.

Existing e-commerce systems typically lack detailed feedback and review mechanisms for products and services. Detailed reviews and feedback are crucial for evaluating service and products quality and vendor performance. The absence of such mechanisms can lead to a lack of accountability and difficulty in identifying reliable vendors.

To address these shortcomings, there is a need for an improved computer-implemented e-commerce system and method that provides a comprehensive solution for online transactions between authenticated vendors and customers.

### SUMMARY

An illustrative embodiment provides a computer-implemented method for registering vendors and customers within an e-commerce system and facilitating transactions. The method includes receiving, from a vendor, a vendor registration application including vendor information. The method includes receiving, from a customer, a customer registration application including customer information. The method includes receiving consent from the vendor to conduct background checks and conducting background checks on the vendor. The background checks include searching public records and databases for criminal records, financial records, court records, and bankruptcy history of the vendor. The method includes generating a background check report associated with the vendor. The background check report includes findings from the background checks. The method includes assigning a risk score to the vendor based on the background check report. The method includes reviewing the background check report and the assigned risk score and approving or disapproving the vendor's registration based on the review of the background check report and the risk score. If the vendor's registration application is approved, the method includes allowing the vendor to create an account within the system and allowing the vendor to create and manage listings for services and goods, wherein the listings are categorized for browsing by the customer. The method includes reviewing the customer registration application and approving or disapproving the customer registration application based on the review. If the customer's registration is approved, the method includes allowing the customer to create an account and enabling the customer to search, filter, and browse through the categorized listings to identify desired services or goods. The method includes facilitating ordering processes by allowing the customer to add selected items to a shopping cart, review selections, and proceed to checkout. The method includes processing payments securely via a payment processing module that encrypts sensitive customer data during transmission.

Another illustrative embodiment provides a system for facilitating an e-commerce platform. The system includes a storage device configured to store program instructions and one or more processors operably connected to a communication network and the storage device. The system includes an application core module operably connected to the one or more processors and the storage device. The application core module includes a registration module configured to execute the program instructions to cause the system to receive from a vendor a registration application including vendor information The registration module is configured to execute the program instructions to cause the system to receive a customer registration application including customer information. The application core module includes a background check module configured to execute the program instructions to cause the system to conduct background checks on the vendor. The background checks include searching public records and databases for criminal records, financial records, court records, and bankruptcy history. The application core module includes a report generation module configured to execute the program instructions to cause the system to generate a background check report that includes findings from the background check, and to assign a risk score based on the findings. The report generation module is configured to approve or disapprove the vendor's registration application based on the risk score, wherein a vendor with a risk score below a predetermined threshold is approved and a vendor above a predetermined threshold is disapproved. The application core module includes a transaction module configured to execute the program instructions to cause the system to allow the vendor to create and manage listings for services and goods, wherein the listings are categorized for browsing by the customer. The transaction module is configured to enable the customer to search, filter, and browse through categorized listings to identify desired services or goods. The application core module includes a payment processing module configured to execute the program instructions to cause the system to securely process payments, wherein the payment processing module encrypts sensitive customer data during transmission. The application core module includes an order tracking and feedback module configured to execute the program instructions to cause the system to allow the customer to track the status of orders and provide feedback on the services received.

Another illustrative embodiment provides a computer program product for registering vendors and customers within an e-commerce system and facilitating transactions. The computer program product includes a computer-readable storage medium having program instructions embodied thereon to perform the steps of: receiving, from a vendor, a vendor registration application including vendor information; receiving, from a customer, a customer registration application including customer information; receiving consent from the vendor to conduct background checks; conducting background checks on the vendor, wherein the background checks include searching public records and databases for criminal records, financial records, court records, and bankruptcy history of the vendor; generating a background check report associated with the vendor, wherein the background check report includes findings from the background checks; assigning a risk score to the vendor based on the background check report; reviewing the background check report and the assigned risk score; approving or disapproving the vendor's registration based on the review of the background check report and the risk score; if the vendor's registration application is approved, allowing the vendor to create an account within the system and allowing the vendor to create and manage listings for services and goods, wherein the listings are categorized for browsing by the customer; reviewing the customer registration application and approving or disapproving the customer registration application based on the review; if the customer's registration is approved, allowing the customer to create an account and enabling the customer to search, filter, and browse through the categorized listings to identify desired services or goods; facilitating ordering processes by allowing the customer to add selected items to a shopping cart, review selections, and proceed to checkout; and processing payments securely via a payment processing module that encrypts sensitive customer data during transmission.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a pictorial representation of a network of a data processing system in which illustrative embodiments may be implemented;

FIG. 2A illustrates a block diagram of a system in accordance with an illustrative embodiment;

FIG. 2B illustrates an application core module in accordance with an illustrative embodiment;

FIG. 3 illustrates a block diagram of a system in accordance with an illustrative embodiment;

FIGS. 4-10 illustrate flowcharts of processes in accordance with an illustrative embodiment; and

FIG. 11 illustrates a block diagram of a data processing system in accordance with an illustrative embodiment.

### DETAILED DESCRIPTION

The illustrative embodiments provide a computer-implemented method and system for facilitating transactions between vendors and supplier and customers. The illustrative embodiments address the limitations associated with existing methods and systems. The illustrative embodiments provide a computer-implemented e-commerce platform which allow vendors, suppliers and customers to register and open accounts. The illustrative embodiments provide review of credentials, licenses and certifications of vendors and suppliers. The illustrative embodiments conduct background checks of vendors and suppliers. The illustrative embodiments facilitate secure payment processing and offer enhanced feedback and review mechanisms by customers.

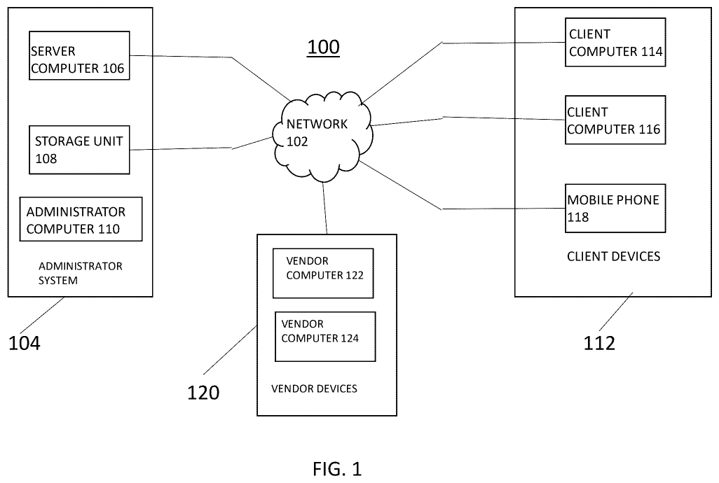

With reference to FIG. 1, a pictorial representation of a network of data processing system is depicted in which illustrative embodiments may be implemented. Network data processing system 100 is a network of computers in which the illustrative embodiments may be implemented. Network data processing system 100 includes network 102, which is the medium used to provide communications links between various devices and computers connected within network data processing system 100. Network 102 may include connections, such as wire, wireless links, and/or fiber optic cables.

System 100 includes administrator system 104 configured to enable system administrators to control, manage, and oversee various aspects of system 100. Administrator system 104 allows system administrators to configure and manage applications within system 100 and manage services offered by system 100. Administrator system 104 provides system administrators with a centralized platform to perform a wide range of tasks for operation and maintenance of system 100.

Administrator system 104 allows system administrators to manage vendors and suppliers and customers, review applications submitted by vendors and suppliers, and review and verify their credentials, licenses and documents. In this document, the terms “vendor” and “supplier” are used interchangeably. A vendor or a supplier may be a provider of services or products.

In the illustrative embodiment, system administrators can define and publish information relating to customers and vendors. Administrator system 104 enables communication such as emails, SMS and fax among vendors and customers. Administrator system 104 can maintain ledgers of financial transactions.

In an illustrative embodiment, administrator system 104 may include server computer 106, storage unit 108 and administrator computer 110. Server computer 106, storage unit 108 and administrator computer 110 connect to network 102.

System 100 includes client devices 112 which connect to network 102. A client (e.g., customer) can communicate with vendors and system administrators using client devices 112. Client devices 112 can include, for example, computers, workstations, or network computers. As depicted, client devices 112 include client computers 114 and 116. Client devices 112 can also include other types of devices such as mobile phone 118.

System 100 includes vendor devices 120 which connect to network 102. Vendors can communicate using vendor devices 120. Vendor devices 120 can include, for example, computers, workstations, or network computers. As depicted, vendor devices 120 include vendor computers 122 and 124. Vendor devices 120 can also include other types of devices such as mobile phones.

In the illustrative example of FIG. 1, administrator system 104, client devices 112 and vendor devices 120 are network devices that connect to network 102 in which network 102 is the communications media for these network devices. Administrator system 104, client devices 112 and vendor devices 120 may exchange information with each other over network 102.

Program code located in network data processing system 100 can be stored on a computer-recordable storage medium and downloaded to a data processing system or other devices for use. For example, the program code can be stored on a computer-recordable storage medium in server computer 106 and/or storage unit 108 and downloaded to client devices 112 and vendor devices 120 over network 102.

Program code located in network data processing system 100 facilitates online registration and transaction by vendors and customers. Program code allows a vendor to register within system 100. Program code allows a vendor to submit credentials, licenses and other background information. Program code allows for detailed credential reviews including verification of vendor submitted credentials, licenses and background information. In an example embodiment, program code includes code for conducting background checks of the vendors. Program code includes code configured to search background information of vendors, including, court records, criminal records, arrest records and financial records from external databases and publicly available sources. In an example embodiment, system 100 requires vendors to consent to background checks including court records, criminal records and financial records as condition for registering within system 100. As such, system 100 provides an e-commerce platform through which customers can hire or engage verified vendors and engage in e-commerce transactions safely. Program code facilitates secure and seamless payment processing and allows feedback and review mechanisms by customers.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

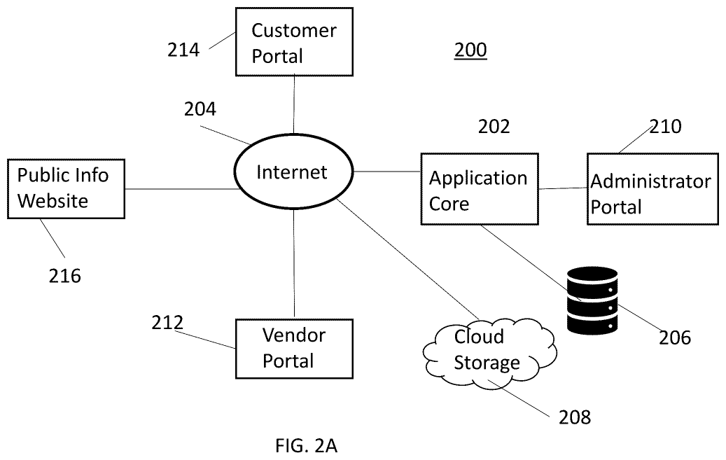

FIG. 2A is a block diagram of system 200 in accordance with an illustrative embodiment. In one aspect, system 200 is an e-commerce platform which addresses the limitations associated with existing methods and systems.

As depicted in FIG. 2A, system 200 includes application core 202 connected to network 204. Network 204 can, for example, be the Internet. Users (e.g., vendors (e.g., service providers), customers and managers may access application core 202 via network 204.

In an illustrative embodiment, application core module 202 includes computer program code configured to facilitate the e-commerce platform. Application core module 202 includes computer program code configured to allow vendors to submit applications and enable verification and authentication of vendor submitted credentials and certifications. In an example embodiment, program code includes code for conducting security and background checks of the vendors. Program code includes code configured to perform background checks of vendors, including searching court records, criminal records, arrest records and financial records from external databases and publicly available sources. In an example embodiment, system 200 requires vendors to consent to background checks including court records, criminal records and financial records as a condition for registering within system 200. If vendors fail background checks, vendors and suppliers are prevented from registering within system. As such, system 200 provides an e-commerce platform through which customers can hire or engage verified vendors and engage in e-commerce transactions safely.

Application core 202 facilitates secure and seamless payment processing and offers enhanced feedback and review mechanisms by customers. The program code can be stored in storage unit 206 and downloaded to other devices for use. The program code can be stored in server computer 106 (FIG. 1) and/or in storage unit 108 (FIG. 1).

In an illustrative embodiment, storage unit 206 comprises one or more hard disk drives and other types of storge devices. Storage unit 206 can be implemented as storage unit 108 (FIG. 1). Storage unit 206 is configured for storing and retrieving data. Storage unit 206 may also comprise solid-state drives which use flash memory to store data. Solid state drives have no moving parts, which makes them more durable and less susceptible to physical damage. Storage unit 206 may also comprise network-attached storage (NAS) which are specialized storage devices that connect to network 202, allowing multiple users or devices to access shared storage. Cloud storage 208 can be used for data backup, file sharing, and remote access to files from different devices.

System 200 includes administrator portal 210 which is a website that brings information together from diverse sources in a unified way. In some embodiments, each information source gets its dedicated area on the page for displaying information. A system administrator can configure which ones to display. Administrator portal 210 provides a broad range of features, including search functionality, email and various other services. In an illustrative embodiment, administrator portal 210 allows the administrator to manage vendors/suppliers and customers (e.g., entities or individuals).

In an illustrative embodiment, administrator portal 210 allows a system administrator to review pending vendor applications, verify vendor-submitted licenses and documents and initiate background checks of the vendors/suppliers. Administrator portal 210 allows the administrator to publish and manage business plans for customers and vendors/suppliers. A published business plan can be revoked if there is no vendor subscribing to it. Administrator portal 210 also allows the administrator to manage emails, SMS and fax order notifications to vendors and customers. In an illustrative embodiment, administrator portal 210 maintains ledgers of financial transactions such as transactions between customers and vendors. The ledgers can be exported as Excel or printed as PDF for reconciliations.

System 200 includes vendor portal 212 which is a website designed to facilitate interactions and transactions among the administrator, vendors and customers. Vendor portal 212 serves as a centralized hub where vendors can access information, manage their accounts, and perform various tasks related to their relationship with the customers and the administrator. Vendor portal 212 streamlines communication, improves efficiency, and enhances the overall supply chain management process.

In an illustrative embodiment, vendor portal 212 allows vendors to register, submit required documentations, certifications, licenses and other background information. Vendors can update contact information through vendor portal 212, and update business details, certifications licenses. Vendors can view purchase orders issued by the customers, acknowledge, confirm, or decline orders. Vendors can track the status of ongoing orders and deliveries. Also, vendors can submit invoices for completed orders, track the status of submitted invoices and payment schedules. Vendors can upload and manage their product catalogs.

System 200 includes customer portal 214 which is a website where customers can manage their interactions with the vendors and the system administrator. Customer portal 214 allows customers to view order history, track progress or work, shipping status, and reorder services and/or products. Customer portal 214 allows customers to update personal details, change passwords, and manage payment methods.

System 200 includes a public information website 216 which is a website accessible to visitors, including potential customers, without the need for login or registration. Public information website 216 serves to inform and attract visitors and potential customers, providing them with essential information about vendors, their services and products, and other relevant content.

In an illustrative embodiment, public information website 216 displays available vendors, services and products with descriptions, images, prices, and other relevant details. Public information website 216 categories and filters vendors and their services and products to help visitors and potential customers find services and products. Public information website 216 may include information about the company which manages system 200, its mission, vision, and history. Public information website 216 may also provide an introduction to the team or key personnel of the company and contact details including email addresses, phone numbers, and physical addresses. Public information website 216 may provide answers to common questions about products, services, shipping, returns, and more. Public information website 216 may include articles, news updates, and informative content related to vendors, services and products, or company updates. Public information website 216 may include customer reviews and testimonials about products and services offered by vendors.

FIG. 2B illustrates application core module 202 in accordance with an illustrative embodiment. Application core module 202 includes registration module 240 which includes computer program code configured to allow vendors and suppliers and customers to submit applications to register and create accounts within system 100 and system 200. Registration module 240 allows vendors to submit personal and business information. Such information may include name of individual, business name, date of birth, email address, physical address, phone number, business information, nature of services and/or products offered and other information related to vendors. Vendors may also submit licenses, certifications, credentials, etc., relating to their business. Vendors are required to submit sufficient information to enable system 100 and system 200 to conduct background checks of vendors. Customers are required to submit information such as, for example, customer name and contact information.

Application core module 202 include background check module 242 configured to conduct background checks of vendors. To enhance the security and trustworthiness of vendors and suppliers on the e-commerce platform (system 100 and system 200), background check module 242 includes program code configured to conduct searches across various public records and databases. This ensures that vendors are thoroughly vetted before being allowed to participate in the marketplace within system 100 and system 200. Background check module 242 includes program code to search criminal records of vendors, including searching any criminal history or charges. Background check module 242 includes program code to search financial records including credit history, outstanding debts, and financial stability. Background check module 242 includes program code to search for ongoing or past litigation involving vendors. Background check module 242 includes program code to search whether vendors have a history of bankruptcy or financial insolvency. Background check module 242 includes program code to conduct checks against watchlists, sanction lists, or other relevant databases.

In an example embodiment, background check module 242 integrates with third-party APIs that specialize in background checks. The APIs query various databases and return a consolidated report.

In an example embodiment, system 100 and system 200 require vendors to consent to background checks including criminal records and financial records as a condition for registering within system 100 and system 200.

In an example embodiment, based on the background check conducted by background check module 242, report generation module 244 consolidates data from the background check into a report that can be reviewed by administrators. The report includes sections for criminal records, financial stability, court cases, bankruptcy history, and any other relevant findings.

In an example embodiment, report generation module 244 assigns a risk score based on the findings. For example, a vendor can be assigned a risk score having a range between 0 and 5, wherein a risk score of 0 indicates the vendor poses minimal risk to the e-commerce platform and customers, and a risk score of 5 indicates the vendor poses high risk to the e-commerce platform and customers.

In some example embodiment, based on the risk score and a predetermined threshold score, report generation module can automatically approve or disapprove a vendor's application for registration. If the risk score is below a predetermined threshold, the vendor is automatically approved without any review by an administrator. If the risk score is above a predetermined threshold, the vendor is automatically disapproved without any review by an administrator. For example, if a vendor receives a risk score of 0, report generation module 244 can automatically approve the vendor's registration without any review by administrators. Conversely, if a vendor receives a risk score of 5, report generation module 244 can automatically reject the vendor's application without any review by administrators.

In some example embodiments, the risk score generated by report generation module 244 is used as an aid by administrators in decision-making. The administrators review the background check report and the risk score. Based on the findings, administrators can approve or disapprove the vendor's registration on the platform. For example, administrators may approve vendors receiving risk score of 2 or lower and reject vendors receiving risk score of 3 or higher. Vendors are notified of the decision, and reasons are provided if disapproved. By thoroughly vetting vendors, system 100 and system 200 ensures a secure environment for customers to purchase services and goods. In an example embodiment, background check module 242 can also periodically re-check or conduct ongoing monitoring of vendors and suppliers to ensure they maintain their verified status.

Application core module 202 includes e-commerce transaction module 246 which includes program code configured to allow vendors to list their services and goods. These listings are categorized for easy browsing by customers, and transaction module 246 facilitates the ordering process.

In an example embodiment, transaction module 246 enables vendors to create and manage listings for the services and goods they offer. These listings are stored in a database and displayed to customers in categorized sections. Vendors can fill out forms detailing their products or services, including titles, descriptions, prices, images, and category selections.

Transaction module 246 allows customers to view listings and order services and goods from vendors. Customers can browse listings organized by categories, making it easier to find the specific goods or services they need. Customers can use search and filtering options to narrow down listings based on keywords, price range, ratings, etc. Once customers have found the services or products they want, they can place orders directly through the platform. Customers can add items to a shopping cart and review their selections before proceeding to checkout.

Application core module 202 includes payment processing module 248 configured to handle payments securely, ensuring customer data is protected. Payment processing module 248 includes program code to connect to a payment processor (e.g., Stripe, PayPal, credit card). Payment processing module 248 ensures all sensitive data (e.g., credit card information) is encrypted during transmission. During checkout, customers provide payment and shipping information. The system processes the payment and creates an order in the database.

Application core 202 includes order tracking and feedback module 250 which includes program code configured to allow customers to track the status of their orders and provide feedback on the services received. Such feedback is stored in a database for review.

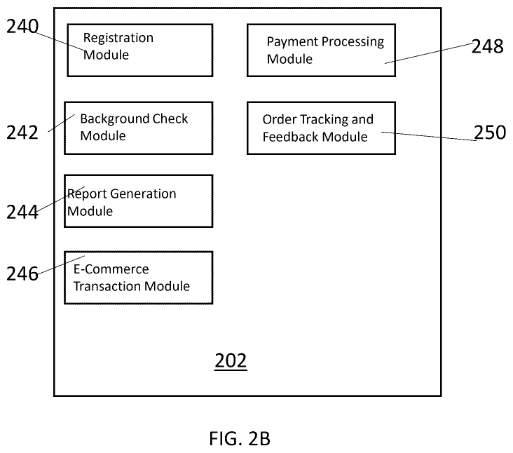

FIG. 3 illustrates a block diagram of system 300 in accordance with an illustrative embodiment. System 300 addresses the limitations of existing systems.

System 300 includes application core 302. In an illustrative embodiment, application core 302 includes computer program code designed to facilitate vendor verification and authentication processes, allow for detailed credential reviews and enable efficient project tracking. Application core 302 facilitates secure payment processing and offers enhanced feedback and review mechanisms by customers. The program code can be stored in a storage unit which may include data warehouse 304. Customer data, vendor data and other data and information may also be stored in data warehouse 304. Data warehouse 304 can be connected to application core 302 via a communication link such as the Internet, wired link, fiber optic link and/or wireless link. The data from data warehouse 304 can be downloaded to other devices for use. In an illustrative embodiment, the data and other information are encrypted/decrypted by encryption/decryption unit 306 for security.

System 300 includes administrator portal 308 (e.g., management portal) which allows administrator/manager 310 to manage system 300. Administrator/manager 310 can be an entity, organization or an individual that controls and manages system 300. Administrator portal 308 allows an administrator to manage vendors and customers. The administrator can review pending vendor applications and verify vendor-submitted licenses and documents. Administrator portal 308 allows the administrator to publish and manage business plans for vendors. Administrator portal 308 allows the administrator to manage emails, SMS and fax order notifications to vendors and customers.

System 300 includes vendor portal 312 which serves as a centralized hub where vendors can access information, register, manage their accounts, and perform various tasks related to their relationship with the customers and the administrator. As shown in FIG. 3, a vendor may be an organization/entity 314 or an individual vendor 315.

Vendor portal 312 streamlines communication, improves efficiency, and enhances the overall supply chain management process. Vendors can update contact information through vendor portal 312, and update business details and certifications. Vendors can view purchase orders issued by the customers, acknowledge, confirm, or decline orders. Vendors can track the status of ongoing orders and deliveries. Also, vendors can submit invoices for completed orders, track the status of submitted invoices and payment schedules. Vendors can upload and manage their service and product catalogs.

In an illustrative embodiment, system 300 provides vendor mobile application 316 which is an application specifically designed for vendors who sell their products or services through the e-commerce platform. Vendor mobile application 316 provides vendors with the tools and features they need to manage their business operations from a mobile device. Vendor mobile application allows vendors to conveniently handle tasks related to inventory, orders, communication, and performance tracking from a mobile device. As shown in FIG. 3, vendors such as, for example, private investigator 318, security guard 320 or licensed instructor 322 can handle tasks related to inventory, orders, communication, and performance tracking from a mobile device.

System 300 includes customer portal 324 which is a secure online interface where customers can manage various aspects of their relationship with vendors and the administrator. Customer portal 324 is configured to enhance the customer experience by providing them with tools and resources to manage their orders, view transaction history, update account information, and access support services. Customer portal 324 allows customers to create and manage their personal accounts and update contact details, addresses, and payment methods. Customer portal 324 allows customers to view their order history and track the status of current orders. Customers can view invoices, manage their payment methods, and view their payment history. Customer portal 324 also allows customers to access customer support resources, including FAQs, live chat, ticket submission, and contact details. Customers can manage their marketing preferences, such as opting in or out of newsletters and promotions. As shown in FIG. 3, a customer can be business 326 or individual 328.

System 300 includes customer mobile app 330 which is a software application designed for mobile devices, such as smartphones and tablets, that allows customers to browse, shop, and manage their accounts on the e-commerce platform. Customer mobile application 330 can be configured for iOS operating systems, Android operating systems and other operating systems and offer a user-friendly interface optimized for mobile use. Customers can view various categories of services and products offered by vendors, view detailed service/product information, compare services/products, and use search filters or keywords to find specific services and items. In an illustrative embodiment, customers can add services/items to their shopping cart, review cart contents, and proceed through a checkout process that includes payment options and order confirmation.

In an illustrative embodiment, customer mobile application 330 allows customers to create and manage their accounts, view order history, track progress of work, update personal details, and manage saved payment methods within the application.

In an illustrative embodiment, customers can receive push notifications for order updates, promotions, new services and product launches, or other relevant information directly on their mobile devices. Customer mobile application 330 provides access to customer support through chat, email, or phone, helping users resolve issues, answer questions, and receive assistance with their orders or account.

In an illustrative embodiment, customer mobile application 330 allows customers to interact directly with vendors, providing a platform for inquiries, service customization requests, or resolving issues related to services or orders. This direct communication can enhance the customer experience and build stronger relationships between customers and vendors. Customer mobile application 330 also provides a channel for customers to interact with system administrators or support staff for technical issues, account problems, or to provide feedback on their experience with vendors. This ensures that any technical or administrative concerns can be promptly addressed, maintaining a smooth and reliable user experience.

System 300 includes a public information website 332 which is a website accessible to visitors, including potential customers, without the need for login or registration. Public information website 332 serves to inform and attract visitors and potential customers, providing them with essential information about vendors, their services and products, and other relevant content.

In an illustrative embodiment, public information website 332 displays available vendors, services and products with descriptions, images, prices, and other relevant details. Public information website 332 categories and filters vendors and their services and products to help visitors and potential customers find services and products. Public information website 332 may include information about the company which manages system 300, its mission, vision, and history. Public information website 332 may also provide an introduction to the team or key personnel of the company and contact details including email addresses, phone numbers, and physical addresses. Public information website 332 may provide answers to common questions about products, services, shipping, returns, and more. Public information website 332 may include articles, news updates, and informative content related to vendors, services and products, or company updates. Public information website 332 may include customer reviews and testimonials about products and services offered by vendors.

In an illustrative embodiment, system includes cloud storage 334 which can be used to store data across all components of system 300. Cloud storage 334 allows data to be stored, managed, and accessed over the internet or other communication links. Cloud storage 334 can be implemented using remote servers hosted by cloud service providers (e.g., AWS, Google Cloud, or Azure). In system 300, cloud storage 334 facilitates handling large volumes of data, ensuring data accessibility, security, and scalability. Cloud storage 334 can be used by application core 302 to store critical data such as vendor catalogs, transaction histories, customer data, and operational logs. This data is stored securely in the cloud, ensuring it is accessible to the various applications (customer, vendor, and administrator) while being protected against data loss or unauthorized access.

Customers interact with cloud storage 334 to access and store user-related data, such as user profiles and order histories. When a customer browses services/products, adds items to their cart, or places an order, all this data can be stored in the cloud. The cloud also allows for quick retrieval of service/product information and images. Cloud storage 334 is used by vendors to upload and manage services/product descriptions, pricing, and availability in real-time. Vendors can also access sales data, performance analytics, and customer feedback stored in the cloud. Administrators can rely on cloud storage 334 to access detailed logs, reports, and data backups. They can monitor and control platform activity, apply updates, and manage user permissions from cloud storage 334. As system 300 grows, cloud storage 334 can scale to accommodate increasing amounts of data, such as more services/product listings, customer information, and transaction records.

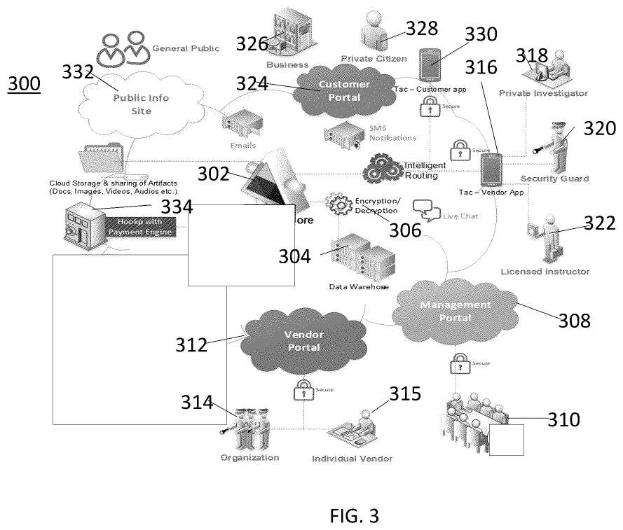

FIG. 4 is a flow diagram of process 400 in accordance with an illustrative embodiment. Process begins when customer 402 signs up (registers) at block 404 within system 100, 200 and 300. This involves creating a new account by providing necessary details such as name, contact information, and other relevant credentials within the system. The registration process ensures that the customer has a unique identity within the platform, allowing them to access various services.

Once the registration is complete, at block 406 the customer can log into system 100, 200 and 300 using their newly created credentials. This step is essential for authentication, ensuring that only authorized users can access their personal accounts and the features available on the platform.

After logging in, at block 408, the customer has the ability to manage their profile. This includes updating personal information, changing contact details, managing security settings such as passwords, and adjusting preferences for notifications and communication.

At block 410, the customer can access their personalized dashboard, which serves as a central hub for navigating the platform. The dashboard provides an overview of the customer's activities, including recent job requests, job postings, transactions, pending actions, and quick links to various features. This centralized view enhances the user experience by making it easier for customers to interact with the platform.

At block 412, the customer can post jobs. The customer can create and post job listings for services or products they require, specifying details such as scope, deadlines, and budget. This feature is useful for customers looking to engage vendors or suppliers for specific tasks or orders.

At block 414, customers can view their job history, which includes a record of all past job postings. This feature allows customers to track the status of previous jobs, review interactions with vendors and suppliers, and assess completed work. It serves as a useful reference for managing ongoing projects and making informed decisions about future engagements.

After posting jobs, at block 416, customers have the ability to view quotes submitted by vendors or suppliers. This feature enables customers to compare different offers, evaluate the proposed terms, and select the most suitable vendor or supplier for their needs. The quote management system ensures transparency and helps customers make cost-effective decisions.

Lastly, at block 418, customers can view various reports generated by the system. These reports may include detailed analyses of spending, job outcomes, vendor or supplier performance, and other key metrics. By reviewing these reports, customers gain valuable insights into their activities on the platform, helping them optimize their interactions and make data-driven decisions.

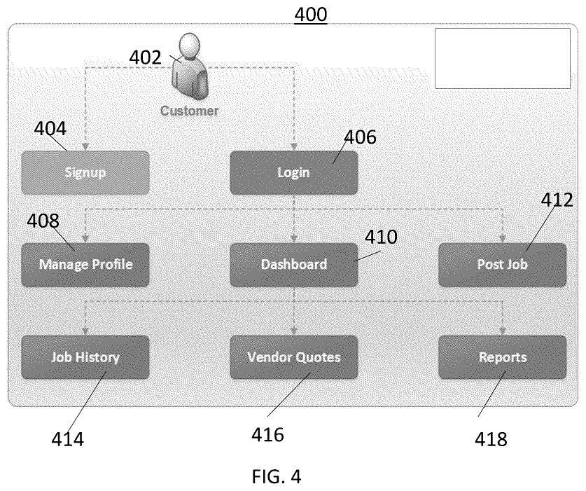

FIG. 5 is a flow diagram of process 500 in accordance with an illustrative embodiment. In process 500, customer 502 interacts with vendor 504 via the system. At block 506, customer can check if vendor 504 has accepted and/or started the job. At block 508, vendor 504 responds to customer 502. If vendor 504 has accepted and/or started the job, at block 510, the job status is set to active, and the system sends emails to customer 502 and vendor 504 with their contact information. If vendor 504 rejected the posted job, customer 502 is notified of the rejection.

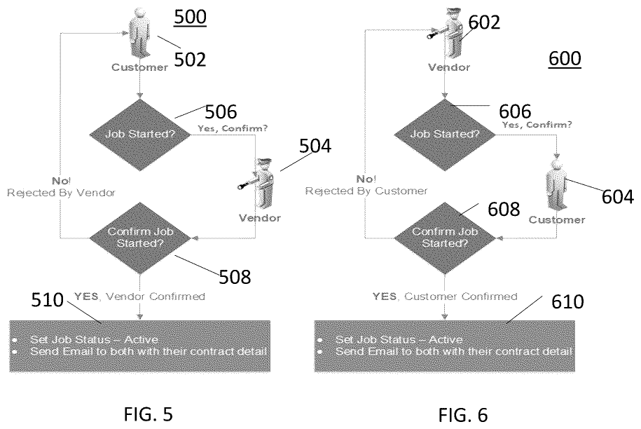

FIG. 6 is a flow diagram of process 600 in accordance with an illustrative embodiment. In process 600, vendor 602 interacts with customer 604. If vendor 602 has accepted and/or started the posted job, at block 606, vendor 602 confirms the acceptance of the posted job. At block 608, customer 604 can reject vendor's offer of acceptance and vendor 602 is notified of the rejection by customer 604. If customer 604 accepts the vendor's acceptance, at block 610, the job status is set to active, and both parties are sent emails with their contact information.

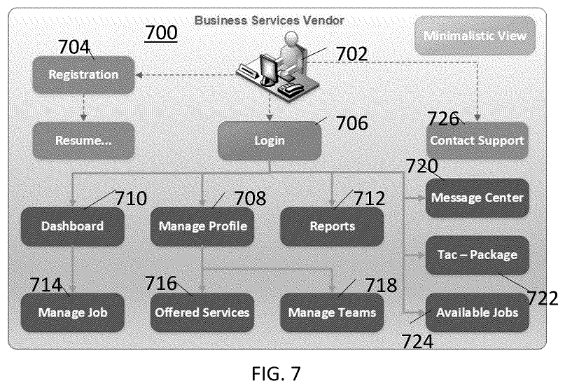

FIG. 7 is a flow diagram of process 700 in accordance with an illustrative embodiment. Process begins when vendor 702 (e.g., business services vendor) signs up or registers at block 704 within system 100, 200 and 300. This involves creating a new account by providing necessary details such as name, contact information, and other relevant credentials within the system. The registration process ensures that the customer has a unique identity within the platform, allowing them to access various services.

Once the registration is complete, at block 706 vendor 702 can log into system 100, 200 and 300 using their created credentials. This step is essential for authentication, ensuring that only authorized vendors can access their personal accounts and the features available on the platform.

After logging in, at block 708, vendor 702 has the ability to manage their profile. This includes updating business information, changing contact details, managing security settings such as passwords, and adjusting preferences for notifications and communication. Vendors can update their business information, service areas, types of services, etc. In an example embodiment, the system may prompt vendors to submit specific permits, licenses, certifications and authorizations. The submitted documentation is validated by a team, and once approved vendors have visibility to the jobs in a region. In an example embodiment, customers can only see the vendors approved for their region under the types of services.

At block 710, the vendor can access their personalized dashboard, which serves as a central hub for navigating the platform. The dashboard provides an overview of the vendor's activities, including services and products offered by the vendor, recent job completions, transactions, pending actions, and quick links to various features. This centralized view enhances the vendor experience by making it easier for vendors to interact with the platform.

At block 712, vendors can view various reports generated by the system. These reports may include detailed analyses of job outcomes, vendor performance, and other key metrics. By reviewing these reports, vendors gain valuable insights into their activities on the platform, helping them optimize their interactions and make data-driven decisions.

At block 714, vendors can manage jobs such as monitor progress of jobs, schedule start date, completion date and other matters related to the jobs. At block 716 vendors can post services which are offered by vendors. Vendors can add or remove services from a list. If a vendor adds a new service, the system may require the vendor to submit relevant licenses, certifications and authorizations. The new service is only available to the customers once it's approved by the system administrator.

At block 718, vendors can manage teams which are assigned to perform services. The system allows vendors to build multiple teams. The jobs can then be assigned to these teams. In an example embodiment, the user accounts can be configured for “Team Members”. The system sends an SMS or an email to validate the information of newly added team members. A job can be assigned to a team and is visible and can be managed by all members of the team.

At block 720, vendors can view messages from customers, team members and system administrators at a message center. Vendors can also send messages to customers, team members and system administrators through the message center. At block 722, vendors can select at least one of the available packages offered by the system. The packages may offer different prices depending on options, payment plans and features. At block 724, vendors can view available jobs posted by customers. At block 726, vendors can contact support staff such as technical support staff. Vendors may also contact support staff to get help before registering with the system. This allows customer service to address the vendors, assist them with their registration and login.

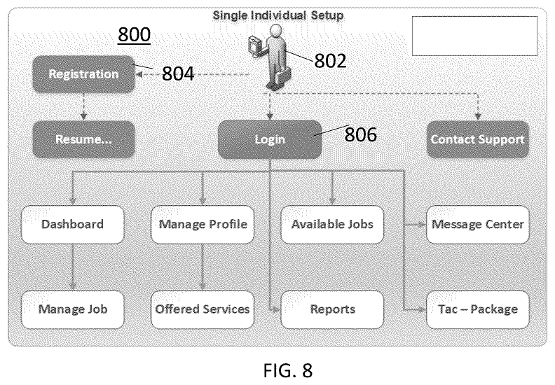

FIG. 8 is a flow diagram of process 800 in accordance with an illustrative embodiment. The process flow of FIG. 8 is similar to the process flow of FIG. 7. Process begins when vendor 802 (individual service provider) signs up or registers at block 804 within system 100, 200 and 300. This involves creating a new account by providing necessary details such as name, contact information, and other relevant credentials within the system. The registration process ensures that the customer has a unique identity within the platform, allowing them to access various services.

Once the registration is complete, at block 806 vendor 802 can log into system 100, 200 and 300 using their created credentials. This step is essential for authentication, ensuring that only authorized vendors can access their personal accounts and the features available on the platform. After logging in, vendor 802 has the ability to manage their profile, access their personalized dashboard, view available jobs and various reports generated by the system. The process flow and functionalities of process 800 is similar to the process flow and functionalities of process 700 shown in FIG. 7.

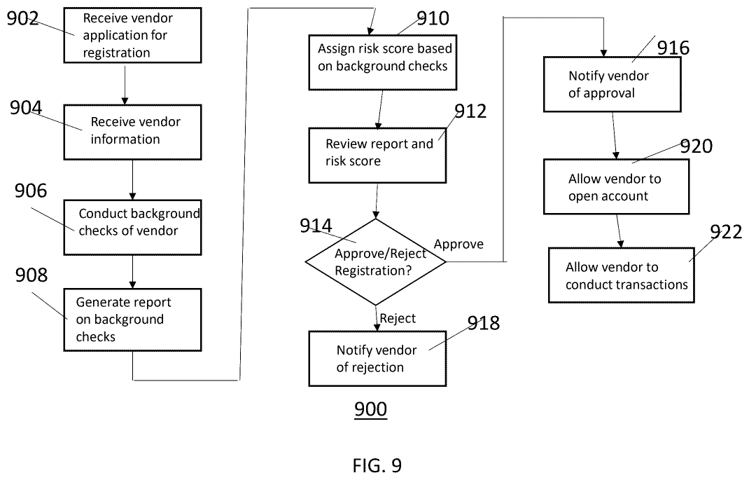

FIG. 9 is a flow diagram of process 900 in accordance with an illustrative embodiment. At block 902, the system (e.g., system 100, 200 and 300) receives an application from a vendor to register and open an account. At block 904, information is received from the vendor, which may include name of individual, business name, date of birth, email address, physical address, phone number, business information, nature of services and/or products offered and other information related to vendors. The vendor can also submit licenses, certifications, credentials, etc., relating to their business.

At block 906, the system conducts a background check of the vendor. To enhance the security and trustworthiness of vendors and suppliers on the e-commerce platform (system 100, system 200 and system 300), the system conducts searches across various public records and databases. This ensures that vendors are thoroughly vetted before being allowed to participate in the marketplace within system 100, 200 and 300. Background checks may include searching any criminal history or charges, financial records including credit history, outstanding debts, financial stability, and any ongoing or past litigation involving vendors. Background checks may include checks against watchlists, sanction lists, or other relevant databases.

In an example embodiment, the system requires vendors to consent to background checks including criminal records and financial records as a condition for registering within the system.

At block 908, data and findings from the background check are consolidated into a report. At block 910, a risk score is assigned to the vendor based on the data and findings from the background checks. For example, a vendor can be assigned a risk score having a range between 0 and 5, wherein a risk score of 0 indicates the vendor poses minimal risk to the e-commerce platform and customers, and a risk score of 5 indicates the vendor poses high risk to the e-commerce platform and customers.

In some example embodiment, based on the risk score, the system can automatically approve or disapprove a vendor's application for registration. For example, if a vendor receives a risk score of 0, the system can automatically approve the vendor's registration without any review by administrators. Also, if a vendor receives a risk score of 5, the system can automatically reject the vendor's application without any review by administrators.

In some example embodiments, the risk score generated by the system is used as an aid by administrators in decision-making. At block 912, the administrators review the background check report and the risk score. At step 914, based on the findings, administrators can approve or disapprove the vendor's registration on the platform. For example, administrators may approve vendors receiving risk score of 2 or lower and reject vendors receiving risk score of 3 or higher. If the vendor is approved, the vendor is notified of the approval at block 916. If the vendor is rejected, the vendor is notified of the rejection at block 918. The vendor can be provided reasons for the rejection. By thoroughly vetting vendors, the system ensures a secure environment for customers to purchase services and goods.

At block 920, the approved vendor is allowed to open accounts within the system. At block 922, the vendor is allowed to conduct transactions within the system. The vendor can create and manage listings for the services and goods they offer. These listings are stored in a database and displayed to customers in categorized sections. The vendor can fill out forms detailing their products or services, including titles, descriptions, prices, images, and category selections.

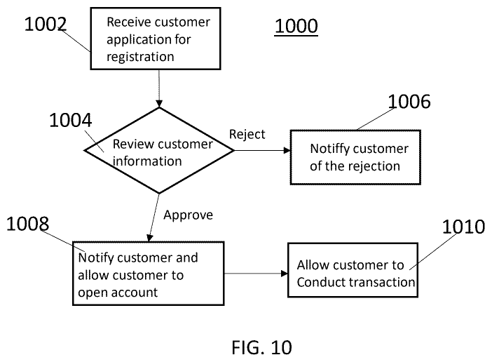

FIG. 10 is a flow diagram of process 1000 in accordance with an illustrative embodiment. At block 1002, the system (e.g., system 100, 200 and 300) receives an application from a customer to register and open an account. At block 1004, the customer's application is reviewed. If the customer's application is rejected, at block 1006, the customer is notified of the rejection. The customer is provided with reasons for the rejection. For example, the customer may be rejected for failure to provide contact information or valid payment information. If the customer's application is rejected by the system, the customer is denied access to the e-commerce platform.

If the customer's application is approved, at block 1008, the customer is notified of the approval and is allowed to open an account within the system. At block 1010, the customer is provided access to the system and allowed to conduct transactions. The customer can browse listings organized by categories, making it easier to find the specific goods or services they need. The customer can use search and filtering options to narrow down listings based on keywords, price range, ratings, etc. Once the customer finds the services or products they want, they can place orders directly through the platform.

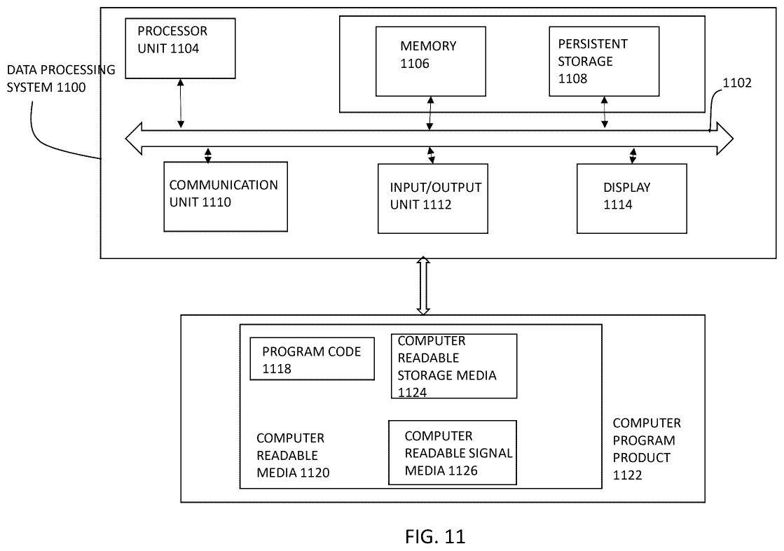

Turning now to FIG. 11, an illustration of a block diagram of a data processing system is depicted in accordance with an illustrative embodiment. Data processing system 1100 may be used to implement system 100 (shown in FIG. 1), system 200 (shown in FIGS. 2A and 2B) and system 300 (shown in FIG. 3). For example, data processing system 1100 may be used to implement administrator system 104, vendor devices 120 and client devices 112. Also, for example, data processing system 1100 may be used to implement application core 202, administrator portal 210, vendor portal 212, customer portal 214 and website 216.

In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (GPUs).

Memory 1106 and persistent storage 1108 are examples of storage devices. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in the storage devices, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for registering vendors and customers within an e-commerce system and facilitating transactions, the method comprising:
receiving, from a vendor, a vendor registration application including vendor information;
receiving, from a customer, a customer registration application including customer information;
receiving consent from the vendor to conduct background checks;
conducting background checks on the vendor, wherein the background checks include searching public records and databases for criminal records, financial records, court records, and bankruptcy history of the vendor;
generating a background check report associated with the vendor, wherein the background check report includes findings from the background checks;
assigning a risk score to the vendor based on the background check report;
reviewing the background check report and the assigned risk score;
approving or disapproving the vendor's registration based on the review of the background check report and the risk score;
if the vendor's registration application is approved, allowing the vendor to create an account within the system and allowing the vendor to create and manage listings for services and goods, wherein the listings are categorized for browsing by the customer;
reviewing the customer registration application and approving or disapproving the customer registration application based on the review;
if the customer's registration is approved, allowing the customer to create an account and enabling the customer to search, filter, and browse through the categorized listings to identify desired services or goods;
facilitating ordering processes by allowing the customer to add selected items to a shopping cart, review selections, and proceed to checkout; and
processing payments via a payment processing module that encrypts sensitive customer data during transmission.

2. The computer-implemented method of claim 1, further comprising preventing the vendor from creating an account within the system if the vendor's registration is disapproved.

3. The computer-implemented method of claim 1, further comprising preventing the customer from creating an account within the system if the customer's registration is disapproved.

4. The computer-implemented method of claim 1, further comprising allowing the customer to track a status of orders and provide feedback on the services or goods received.

5. The computer-implemented method of claim 1, wherein the vendor information includes personal information, business information, contact details, licenses, certifications, and credentials.

6. The computer-implemented method of claim 1, further comprising approving the vendor's registration application without review by an administrator if the risk score is below a predetermined threshold.

7. The computer-implemented method of claim 1, further comprising disapproving the vendor's registration application without review by an administrator if the risk score is above a predetermined threshold.

8. The computer-implemented method of claim 1, further comprising reviewing the background report and the risk score by an administrator, wherein the administrator approves or disapproves the vendor's registration based on the review.

9. A system for facilitating an e-commerce platform, comprising:
a storage device configured to store program instructions;
one or more processors operably connected to a communication network and the storage device;
an application core module operably connected to the one or more processors and the storage device, the application module comprising:
a registration module configured to execute the program instructions to cause the system to receive from a vendor a registration application including vendor information, the registration module configured to execute the program instructions to cause the system to receive a customer registration application including customer information;
a background check module configured to execute the program instructions to cause the system to conduct background checks on the vendor, wherein the background checks include searching public records and databases for criminal records, financial records, court records, and bankruptcy history;
a report generation module configured to execute the program instructions to cause the system to generate a background check report that includes findings from the background check, and to assign a risk score based on the findings, the report generation module further configured to approve or disapprove the vendor's registration application based on the risk score, wherein a vendor with a risk score below a predetermined threshold is approved and a vendor above a predetermined threshold is disapproved;
a transaction module configured to execute the program instructions to cause the system to allow the vendor to create and manage listings for services and goods, wherein the listings are categorized for browsing by the customer, the transaction module further configured to enable the customer to search, filter, and browse through categorized listings to identify desired services or goods;
a payment processing module configured to execute the program instructions to cause the system to process payments, wherein the payment processing module encrypts sensitive customer data during transmission; and
an order tracking and feedback module configured to execute the program instructions to cause the system to allow the customer to track a status of orders and provide feedback on the services received.

10. The system of claim 9, wherein the application core module is configured to execute the program instructions to cause the system to prevent the vendor from creating an account within the system if the vendor's registration application is disapproved.

11. The system of claim 9, wherein the vendor information includes personal information, business information, contact details, business-related documentation, licenses, certifications, and credentials.

12. The system of claim 9, wherein the application core module is configured to execute the program instructions to cause the system to:
enable review of the customer registration application; and
approve or disapprove the customer registration application based on the review.

13. The system of claim 11, wherein the application core module is configured to allow the customer to create an account within the system to enable the customer to search, filter, and browse through the categorized listings to identify desired services or goods if the vendor's registration application is disapproved.

14. A computer program product for registering vendors and customers within an e-commerce system and facilitating transactions, the computer program product comprising:
a computer-readable storage medium having program instructions embodied thereon to perform the steps of:
receiving, from a vendor, a vendor registration application including vendor information;
receiving, from a customer, a customer registration application including customer information;
receiving consent from the vendor to conduct background checks;
conducting background checks on the vendor, wherein the background checks include searching public records and databases for criminal records, financial records, court records, and bankruptcy history of the vendor;
generating a background check report associated with the vendor, wherein the background check report includes findings from the background checks;
assigning a risk score to the vendor based on the background check report;
reviewing the background check report and the assigned risk score;
approving or disapproving the vendor's registration based on the review of the background check report and the risk score;
if the vendor's registration application is approved, allowing the vendor to create an account within the system and allowing the vendor to create and manage listings for services and goods, wherein the listings are categorized for browsing by the customer;
reviewing the customer registration application and approving or disapproving the customer registration application based on the review;
if the customer's registration is approved, allowing the customer to create an account and enabling the customer to search, filter, and browse through the categorized listings to identify desired services or goods;
facilitating ordering processes by allowing the customer to add selected items to a shopping cart, review selections, and proceed to checkout; and
processing payments via a payment processing module that encrypts sensitive customer data during transmission.

15. The computer program product of claim 14, further comprising instructions for preventing the vendor from creating an account within the system if the vendor's registration application is disapproved.

16. The computer program product of claim 14, further comprising instructions for allowing the customer to track a status of orders and provide feedback on the services or goods received.

17. The computer program product of claim 14, wherein the vendor information includes personal information, business information, contact details, licenses, certifications, and credentials.

18. The computer program product of claim 14, further comprising instructions for approving the vendor's registration application without review by an administrator if the risk score is below a predetermined threshold.

19. The computer program product of claim 14, further comprising instructions for disapproving the vendor's registration application without review by an administrator if the risk score is above a predetermined threshold.
